(19) United States
(12) Patent Application Publication
(10) Pub. No.: US 2023/0228355 A1
(43) Pub. Date: Jul. 20, 2023

(54) FLUID CONNECTION ASSEMBLY

(71) Applicant: Oetiker NY, Inc., Lancaster, NY (US)

(72) Inventors: Jeff R. VanMarter, East Amherst, NY (US); Kimberly Romus, Lancaster, NY (US)

(21) Appl. No.: 18/002,372

(22) PCT Filed: Aug. 5, 2020
(86) PCT No.: PCT/US2020/044981

§ 371 Date: Dec. 19, 2022

(51) Int. Cl. F16L 37/098

(52) U.S. Cl. CPC F16L 37/0982

(57) ABSTRACT

A fluid connection assembly, including a connector body, including a first end, a second end including a radially inward extending protrusion, a first through-bore, a gland, and at least one seal arranged in the gland, and a retainer operatively arranged to be removably connected to the connector body, the retainer including a ring portion forming a third end, the third end operatively arranged to enclose the at least one seal in the gland, at least one short finger extending from the ring portion, and at least one long finger extending from the ring portion and terminating at a fourth end, wherein when the retainer is connected to the connector body the at least one long finger extends out of the connector body from the second end.

### CROSS-REFERENCE TO RELATED APPLICATIONS

The present application is a U.S. National Stage Application pursuant to 35 U.S.C. § 371 of International Patent Application No. PCT/US2020/044981, filed on Aug. 5, 2020, which application is hereby incorporated by reference in its entirety.

### FIELD

The present disclosure relates to fluid connectors, and, more particularly, to a fluid connection assembly including a polymer retainer that decreases the insertion force required for assembly while also allowing for disassembly.

### BACKGROUND

Fluid connectors, fluid connections and fluid connection assemblies are integral components for many applications, and especially for automotive applications. Since an automotive system is made up of various components such as a radiator, transmission, and engine, fluid must be able to travel not only within each component but also between components. An example of fluid traveling between components is the transmission fluid traveling from the transmission to the transmission oil cooler in order to lower the temperature of the transmission fluid. Fluid predominantly moves between components via flexible or rigid hoses which connect to each component by fluid connectors. Such fluid connectors typically include a retaining clip, retaining ring clip, or snap ring carried on the connector body which is adapted to snap behind a raised shoulder of a tube end form when the tube end form is fully inserted into the connector body. However, in order for the fluid connector to properly function, slots or apertures must be machined in the connector body such that the retaining clip can protrude therethough and engage the tube end form, which requires extra post-process manufacturing. Additionally, during the assembly process, installation of the retaining clip onto the connector body is difficult and failure to install the retaining clip properly can jeopardize the structural integrity of the retaining clip. Furthermore, since the retaining clips are very thin and small, it is easy to lose them if dropped or misplaced.

Thus, there has been a long-felt need for a fluid connection assembly including a retainer that allows for disassembly, eliminates the need for post-process machining, and reduces the insertion force required to assemble the fluid connector.

### SUMMARY

According to aspects illustrated herein, there is provided a fluid connection assembly, comprising a connector body, including a first end, a second end including a radially inward extending protrusion, a first through-bore, a gland, and at least one seal arranged in the gland, and a retainer operatively arranged to be removably connected to the connector body, the retainer including a ring portion forming a third end, the third end operatively arranged to enclose the at least one seal in the gland, at least one short finger extending from the ring portion, and at least one long finger extending from the ring portion and terminating at a fourth end, wherein when the retainer is connected to the connector body the at least one long finger extends out of the connector body from the second end.

In some embodiments, the at least one short finger comprises a radially outward extending projection operatively arranged to engage the radially inward extending protrusion. In some embodiments, the radially outward extending projection comprises a frusto-conical surface. In some embodiments, the connector body further comprises a frusto-conical radially inward facing surface adjacent the protrusion, and the radially outward extending projection is operatively arranged to engage the frusto-conical radially inward facing surface. In some embodiments, the connector body further comprises at least one hole aligned with the frusto-conical radially inward facing surface. In some embodiments, when the retainer is connected to the connector body, the at least one hole is aligned with the at least one short finger. In some embodiments, the at least one long finger comprises a radially inward extending projection. In some embodiments, the fluid connection assembly further comprises a tube including a shoulder, wherein the radially inward extending projection is operatively arranged to engage the shoulder to lock the tube in the retainer. In some embodiments, the at least one short finger and the at least one long finger are separated by at least one slit. In some embodiments, the connector body further comprises a pocket, the radially outward extending projection operatively arranged to engage the pocket. In some embodiments, the connector body further comprises at least one hole aligned with the pocket, wherein the at least one hole provides access to the radially outward extending projection. In some embodiments, the retainer comprises a polymer.

According to aspects illustrated herein, there is provided a fluid connection assembly, comprising a connector body, including a first end, a second end, a first through-bore, a gland, and at least one seal arranged in the gland, and a retainer removably connected to the connector body, the retainer including a ring portion, a plurality of short fingers extending from the ring portion and operatively arranged to connect the retainer to the connector body, and a plurality of long fingers extending from the ring portion, wherein when the retainer is connected to the connector body, the plurality of long fingers extend out of the connector body from the second end.

In some embodiments, the connector body further comprises at least one recess arranged proximate the second end. In some embodiments, each of the plurality of short fingers comprises a radially outward extending projection operatively arranged to engage the at least one recess to lock the retainer in the connector body. In some embodiments, the connector body further comprises at least one hole aligned with the at least one recess, wherein when the retainer is connected to the connector body, the at least one hole provides access to the radially outward extending projections. In some embodiments, the at least one recess comprises a continuous frusto-conical radially inward facing surface. In some embodiments, the at least one recess comprises a plurality of circumferentially spaced pockets. In some embodiments, the fluid connection assembly further comprises a tube including a shoulder, each of the plurality of long fingers comprises a radially inward extending projection, and the radially inward extending projections are operatively arranged to engage the shoulder outside of the connector body to lock the tube to the retainer.

According to aspects illustrated herein, there is provided a fluid connection assembly, comprising a connector body, including a first end, a second end, a first through-bore, a gland, and at least one seal arranged in the gland, a retainer removably connected to the connector body, the retainer including a ring portion operatively arranged to enclose the at least one seal in the gland, at least one short finger extending from the ring portion, completely enclosed within the connector body, and operatively arranged to lock the retainer to the connector body, and at least one long finger extending from the ring portion, and a tube including a shoulder, wherein the at least one long finger engages the shoulder outside of the connector body to lock the tube to the retainer.

According to aspects illustrated herein, there is provided a quick connector assembly or quick connection mechanism that provides an ergonomically friendly, durable connection of a tube and connector body. The quick connector assembly addresses several problems: the design of the connection assembly reduces tube insertion forces into the connector body; the design of the connection assembly drives geometry changes within the connector body that makes machining the connector body more simple while reducing the cost of thereof; the connection assembly design improves tube retention to the connector body while minimizing axial travel of the tube; the connection assembly design provide for easier serviceability and disassembly; and, the connection assembly design simplifies the assembly process of the connector body as well as the insertion of the tube in the connector body.

In some embodiments, the connection assembly comprises a connector body, a tube, and a plastic retainer. The plastic or polymer retainer replaces current metal retainer technology and reduces insertion forces and machining costs, and simplifies the overall assembly. In some embodiments, the retainer forms half (the top half) of the seal or O-ring gland.

In some embodiments, the connector body comprises a straight bore to improve machinability and reduce costs. The O-ring is placed in the open O-ring gland. A backup ring (or backup rings) is placed on top of O-ring. The base diameter of the plastic retainer is large at the base so that it creates the top surface of the O-ring gland to seal the assembly. There are short and long fingers in this single piece retainer. The short fingers connect the retainer to the connector body and the long fingers connect the tube to the retainer.

The single retainer provides three functions: it creates the top sealing surface of the O-ring gland; it retains itself within the connector body (via the short fingers); and, it retains the tube (via the long fingers).

The short finger snap profile angle that snaps into the connector body has the same profile angle on the mating connector body recessed shoulder or protrusion. In some embodiments, the angled provide of the short finger projections and the recessed surface of the connector body may comprise a 15-degree angle to allow for easier assembly (i.e., lower insertion force) yet improved retention. As the retainer is pressed/inserted into the connector body, it snaps in under the top ledge of the recessed shoulder. The through-bores circumferentially arranged in the connector body allow for access to the snaps, for example, by a disconnect too.

The long fingers of the retainer are operatively arranged to allow easy tube insertion and to limit axial movement of the tube relative to the retainer (and connector body). As the tube is inserted into the retainer (and connector body), the long fingers easily expand (due to the recess in the leg that thins out the leg allowing to be more spring like) and snap back to engage the tube bead. The relationship of the radius of the snap hook is perpendicular to the tube bead radius. This is optimized in order maintain retention of the tube.

In some embodiments, a retainer is provided for a new tube design including short and long fingers. The retainer serves as the top of the O-ring groove/gland and sealing surface. Through-bores circumferentially arranged on the connector body allow access to the short fingers. The short fingers snap in to grooves or pockets within the connector body to lock the retainer within the connector body. The long fingers snap over an edge of the tube and lock the tube to the retainer (and connector body).

These and other objects, features, and advantages of the present disclosure will become readily apparent upon a review of the following detailed description of the disclosure, in view of the drawings and appended claims.

### BRIEF DESCRIPTION OF THE DRAWINGS

Various embodiments are disclosed, by way of example only, with reference to the accompanying schematic drawings in which corresponding reference symbols indicate corresponding parts, in which:

FIG. 1 is a perspective view of a fluid connection assembly;

FIG. 2 is an exploded perspective view of the fluid connection assembly shown in FIG. 1;

FIG. 3A is a perspective view of the retainer shown in FIG. 1;

FIG. 3B is an elevational view of the retainer shown in FIG. 3A;

FIG. 4 is a cross-sectional view of the fluid connection assembly taken generally along line 4-4 in FIG. 1;

FIG. 5 is a cross-sectional view of the fluid connection assembly taken generally along line 5-5 in FIG. 1;

FIG. 6 is a perspective view of a fluid connection assembly;

FIG. 7 is an exploded perspective view of the fluid connection assembly shown in FIG. 6;

FIG. 8A is a perspective view of the retainer shown in FIG. 6;

FIG. 8B is an elevational view of the retainer shown in FIG. 8A;

FIG. 9 is a cross-sectional view of the fluid connection assembly taken generally along line 9-9 in FIG. 6; and,

FIG. 10 is a cross-sectional view of the fluid connection assembly taken generally along line 10-10 in FIG. 6.

### DETAILED DESCRIPTION

At the outset, it should be appreciated that like drawing numbers on different drawing views identify identical, or functionally similar, structural elements. It is to be understood that the claims are not limited to the disclosed aspects.

Furthermore, it is understood that this disclosure is not limited to the particular methodology, materials and modifications described and as such may, of course, vary. It is also understood that the terminology used herein is for the purpose of describing particular aspects only, and is not intended to limit the scope of the claims.

Unless defined otherwise, all technical and scientific terms used herein have the same meaning as commonly understood to one of ordinary skill in the art to which this disclosure pertains. It should be understood that any methods, devices or materials similar or equivalent to those described herein can be used in the practice or testing of the example embodiments. The assembly of the present disclosure could be driven by hydraulics, electronics, pneumatics, and/or springs.

It should be appreciated that the term “substantially” is synonymous with terms such as “nearly,” “very nearly,” “about,” “approximately,” “around,” “bordering on,” “close to,” “essentially,” “in the neighborhood of,” “in the vicinity of,” etc., and such terms may be used interchangeably as appearing in the specification and claims. It should be appreciated that the term “proximate” is synonymous with terms such as “nearby,” “close,” “adjacent,” “neighboring,” “immediate,” “adjoining,” etc., and such terms may be used interchangeably as appearing in the specification and claims. The term “approximately” is intended to mean values within ten percent of the specified value.

It should be understood that use of “or” in the present application is with respect to a “non-exclusive” arrangement, unless stated otherwise. For example, when saying that “item x is A or B,” it is understood that this can mean one of the following: (1) item x is only one or the other of A and B; (2) item x is both A and B. Alternately stated, the word “or” is not used to define an “exclusive or” arrangement. For example, an “exclusive or” arrangement for the statement “item x is A or B” would require that x can be only one of A and B. Furthermore, as used herein, “and/or” is intended to mean a grammatical conjunction used to indicate that one or more of the elements or conditions recited may be included or occur. For example, a device comprising a first element, a second element and/or a third element, is intended to be construed as any one of the following structural arrangements: a device comprising a first element; a device comprising a second element; a device comprising a third element; a device comprising a first element and a second element; a device comprising a first element and a third element; a device comprising a first element, a second element and a third element; or, a device comprising a second element and a third element.

Moreover, as used herein, the phrases “comprises at least one of” and “comprising at least one of” in combination with a system or element is intended to mean that the system or element includes one or more of the elements listed after the phrase. For example, a device comprising at least one of: a first element; a second element; and, a third element, is intended to be construed as any one of the following structural arrangements: a device comprising a first element; a device comprising a second element; a device comprising a third element; a device comprising a first element and a second element; a device comprising a first element and a third element; a device comprising a first element, a second element and a third element; or, a device comprising a second element and a third element. A similar interpretation is intended when the phrase “used in at least one of:” is used herein. Furthermore, as used herein, “and/or” is intended to mean a grammatical conjunction used to indicate that one or more of the elements or conditions recited may be included or occur. For example, a device comprising a first element, a second element and/or a third element, is intended to be construed as any one of the following structural arrangements: a device comprising a first element; a device comprising a second element; a device comprising a third element; a device comprising a first element and a second element; a device comprising a first element and a third element; a device comprising a first element, a second element and a third element; or, a device comprising a second element and a third element.

By “non-rotatably connected” elements, we mean that: the elements are connected so that whenever one of the elements rotate, all the elements rotate; and relative rotation between the elements is not possible. Radial and/or axial movement of non-rotatably connected elements with respect to each other is possible, but not required.

It should be appreciated that the term “tube” as used herein is synonymous with hose, pipe, channel, conduit, or any other suitable pipe flow used in hydraulics and fluid mechanics. It should further be appreciated that the term “tube” can mean a rigid or flexible conduit of any material suitable for containing and allowing the flow of a gas or a liquid.

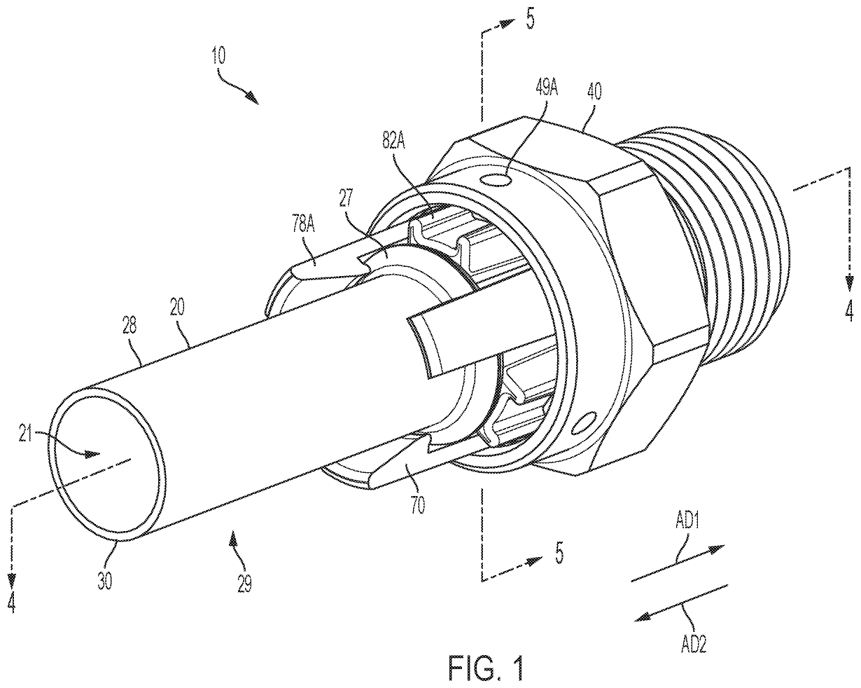

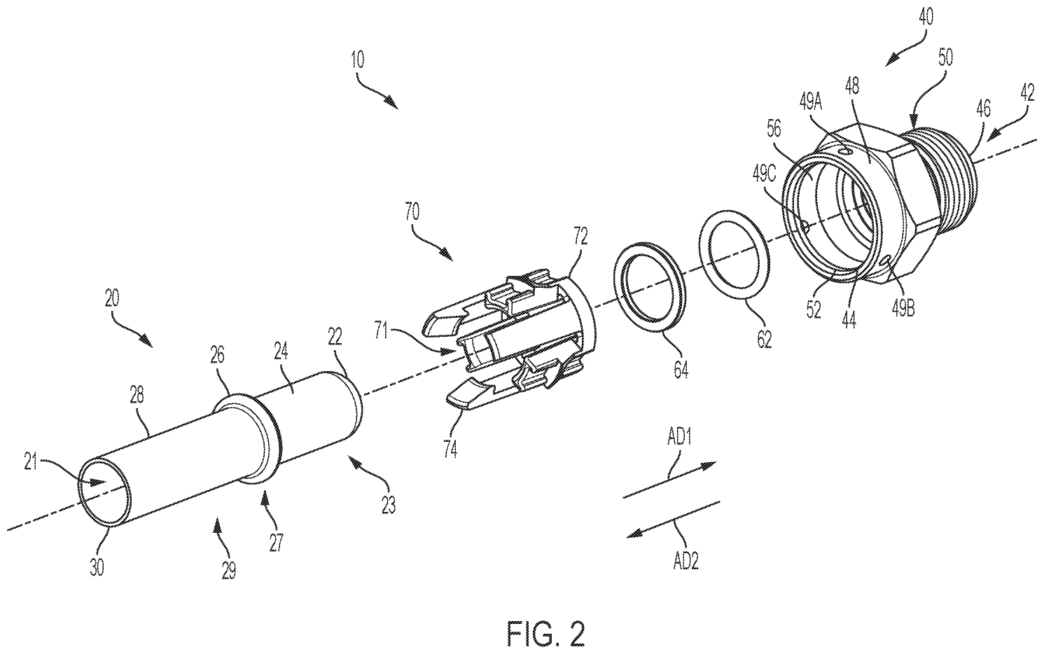

Adverting now to the figures, FIG. 1 is a perspective view of fluid connection assembly 10. FIG. 2 is an exploded perspective view of fluid connection assembly 10. Fluid connection assembly 10 generally comprises tube 20 or tube end form or hose, connector body 40, and retainer 70. The following description should be read in view of FIGS. 1-2.

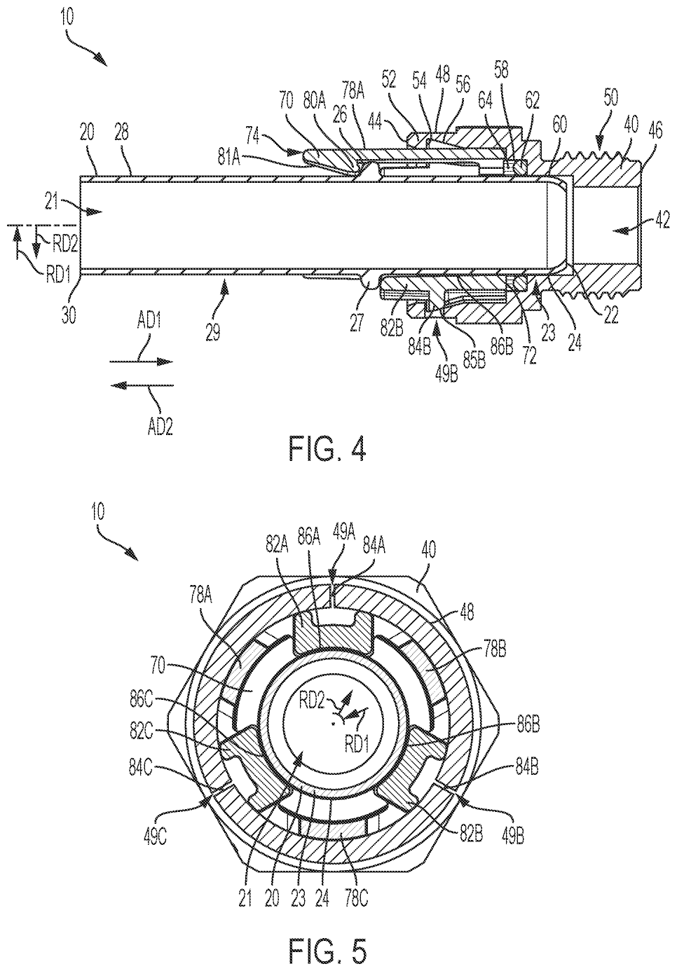

Tube 20 comprises end 22, section 23, shoulder or bead 27, section 29, end 30, and through-bore 21. Through-bore 21 extends through tube 20 from end 22 to end 30. Section 23 is arranged between end 22 and shoulder 27 and comprises radially outward facing surface 24. Radially outward facing surface 24 includes a substantially constant diameter. Shoulder 27 is arranged between section 23 and section 29 and comprises outward facing surface 26. Outward facing surface 26 is curvilinear (i.e., parabolic in shape as best shown in FIG. 4). Section 29 is arranged between shoulder 27 and end 30 and comprises radially outward facing surface 28. Radially outward facing surface 28 includes a substantially constant diameter. Tube 20 is arranged to be inserted, specifically with end 22 first, into connector body 40. Tube 20 is inserted into connector body 40, in axial direction AD1, until retainer 70 snaps over shoulder 27 and is generally engages section 29 (i.e., fingers 78A-C are aligned with section 29), as will be described in greater detail below It should be appreciated that tube 20 may be any traditional tube end form comprising a shoulder (e.g., a ramp), which extends radially outward on the outer surface of the tube, to displace a retainer of the connector body to secure the tube within the connector body. For example, tube 20 may comprise a shoulder including a straight ramp (i.e., constant linear ramp) or a curvilinear ramp. In some embodiments, tube 20 comprises any tube end form that might utilize a retainer. For example, instead of a bead or a ramp-like shoulder, tube 20 may comprise a notch, a plurality of ramps, threading, a shoulder having a variable diameter portion (ramp) and a constant diameter portion connected thereto, any standard Society of Automotive Engineers (SAE) end form, etc. The present disclosure should not be limited to the use of only the tube shown in the figures, but rather any tube end form suitable for fluidly connecting to a connector body via a retainer. It should be appreciated that in some embodiments, and as shown, tube 20 comprises a frusto-conical surface at end 22. Such frusto-conical surface aids in properly aligning tube 20 with respect to retainer 70 and connector body 40 during insertion of tube 20 into retainer 70.

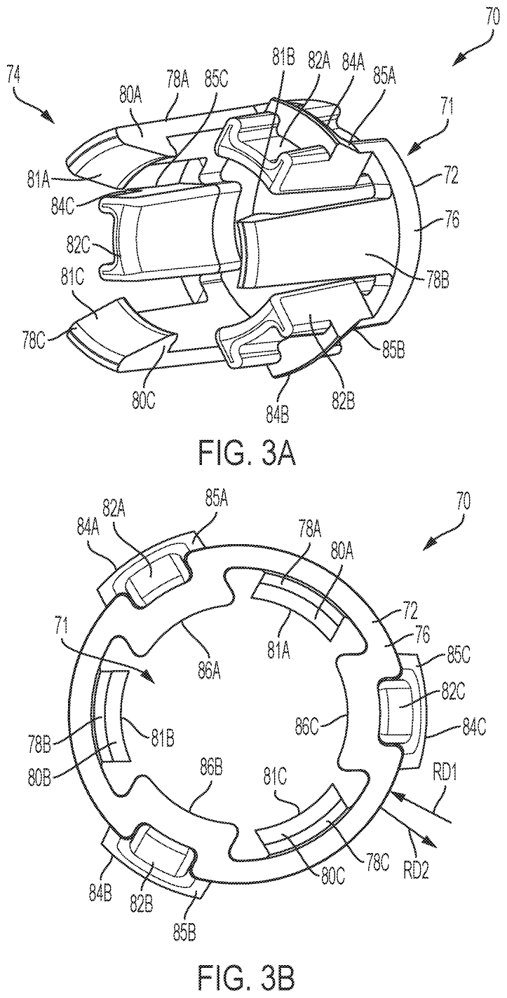

FIG. 3A is a perspective view of retainer 70. FIG. 3B is an elevational view of the retainer 70. The following description should be read in view of FIGS. 1-3B.

Retainer 70 generally comprises ring portion 76 forming end 72 and a plurality fingers (e.g., fingers 78A-C and fingers 82A-C) extending from ring portion 76 and forming end 74. Ring portion 76 is generally ring shaped and comprises through-bore 71. In some embodiments, when retainer 70 is fully inserted into connector body 40, end 72 is operatively arranged to create the second half of the seal or O-ring gland, as will be described in greater detail below.

Fingers 78A-C extend from ring portion 76 in axial direction AD2 and are operatively arranged to engage shoulder 27 of tube 20. Fingers 78A-C comprise radially inward extending projections 80A-C, respectively. Projections 80A-C extend in radial direction AD1 and, when engaged with shoulder 27, lock tube 20 in retainer 70 (and connector body 40). Fingers 78A-C further comprise frusto-conical surfaces 81A-C, respectively. As tube 20 is inserted into retainer 70 in axial direction AD1, frusto-conical surfaces 81A-C engage surface 26 of shoulder 27 forcing fingers 78A-C radially outward (i.e., in radial direction RD2). Once projections 80A-C are aligned with section 29, fingers 78A-C snap back radially inward (i.e., in radial direction RD1) and secure tube 20 within retainer 70. Fingers 78A-C are elastic and are operatively arranged to flex and/or bend relative to ring portion 76. In some embodiments, retainer 70 comprises a polymer. In some embodiments, fingers 78A-C comprise a recess or thinned out portion that allows greater flexion.

Fingers 82A-C extend from ring portion 76 in axial direction AD2 and are operatively arranged to engage protrusion 52 and surface 56 of connector body 40. Fingers 82A-C comprise radially outward extending projections 84A-C, respectively. Projections 84A-C extend in radial direction AD2 and, when engaged with radially inward extending protrusion 52, lock retainer 70 in connector body 40. Fingers 82A-C further comprise frusto-conical surfaces 85A-C, respectively. As retainer 70 is inserted into connector body 40 in axial direction AD1, frusto-conical surfaces 85A-C engage protrusion 52 of connector body 40 forcing fingers 82A-C radially inward (i.e., in radial direction RD1). Once projections 84A-C are aligned with surface 56, fingers 82A-C snap back radially outward (i.e., in radial direction RD2) and secure retainer 70 within connector body 40. Specifically, protrusion 52 of connector body 40 engages projections 84A-C, thereby preventing displacement of retainer 70 in axial direction AD2 with respect to connector body 40. Fingers 82A-C are elastic and are operatively arranged to flex and/or bend relative to ring portion 76. In some embodiments, when retainer 70 is secured in connector body 40, fingers 82A-C and projections 84A-C are aligned with holes 49A-C. Such alignment allows a user to displace fingers 82A-C radially inward (i.e., in radial direction AD1) to disengage projections 84A-C from protrusion 52 and remove retainer 70 from connector body 40. Fingers 82A-C further comprise radially inward facing surfaces 86A-C, respectively. Radially inward facing surfaces 86A-C are operatively arranged to engage tube 20, specifically radially outward facing surface 24 of section 23. In some embodiments, and as shown, fingers 78A-C and fingers 82A-C alternate circumferentially. In some embodiments, fingers 78A-C and fingers 82A-C do not alternate every single finger.

FIG. 4 is a cross-sectional view of fluid connection assembly 10 taken generally along line 4-4 in FIG. 1. FIG. 5 is a cross-sectional view of fluid connection 10 assembly taken generally along line 5-5 in FIG. 1. The following description should be read in view of FIGS. 1-5.

Connector body 40 comprises end 44, end 46, and through-bore 42 extending from end 44 to end 46. Connector body 40 comprises radially outward facing surface 48 comprising one or more release holes (e.g., 49A-C) and radially outward facing surface 50. Holes 49A-C are operatively arranged to align with fingers 82A-C and allow for a user to displace fingers 82A-C radially inward in order to disengage projections 84A-C from protrusion 52. Radially outward facing surface 50 is operatively arranged to connect connector body 40 to another component, and may comprise threading. Connector body 40 further comprises radially inward extending protrusion 52 having (axial) surface 54, frusto-conical surface 56, gland or surface 58, and radially inward facing surface 60. Radially inward facing surface 60 is operatively arranged to engage radially outward facing surface 24 of tube 20. Gland 58 is operatively arranged to at least partially enclose one or more seals (e.g., seals 62 and 64). In some embodiments, fluid connection assembly 10 comprises an O-ring 62 and backup ring 64 arranged in gland 58. When retainer 70 is locked in connector body 40, end 72 encloses seals 62 and 64 completely within gland 58. Seals 62 and 64 are operatively arranged to engage radially outward facing surface 24 to fluidly seal connector body 40 and tube 20. It should be appreciated that in some embodiments, gland 58 is arranged as a groove in radially inward facing surface 60 that fully encloses both sides of the one or more seals. In such embodiments, end 72 of retainer 70 does not enclose the seals within the gland. Frusto-conical surface 56 and protrusion 52, specifically surface 54, are operatively arranged to engage projections 84A-C of fingers 82A-C to lock retainer 70 within connector body 40, as previously described.

To assemble fluid connection assembly 10, seals 62 and 64 are arranged in gland 58 and retainer 70 is then inserted in axial direction AD1, with end 72 first, into connector body 40. As retainer 70 is inserted into connector body 40, frusto-conical surfaces 85A-C of projections 84A-C engage radially inward extending protrusion 52 thereby displacing fingers 82A-C radially inward. Once projections 84A-C are properly aligned with frusto-conical surface 56, fingers 82A-C snap back radially outward, and projections 84A-C engage surface 54 of protrusion 52 thereby securing retainer 70 in connector body 40. Then tube 20 is inserted in axial direction AD1, with end 22 first, into retainer 70. As tube 20 is inserted into retainer 70, frusto-conical surfaces 81A-C of projections 80A-C engage shoulder 27 displacing fingers 78A-C radially outward. Once projections 80A-C are aligned with section 29, fingers 78A-C snap back radially inward, and projections 80A-C engage shoulder 27 and radially outward facing surface 28, thereby securing tube 20 in retainer 70.

It should be appreciated that, when retainer 70 is fully assembled to connector body 40, fingers 78A-C extend out of, in axial direction AD2, connector body 40. Thus, when tube 20 is subsequently inserted into retainer 70, protrusions 80A-C of fingers 78A-C engage shoulder 27 outside of connector body 40, rather than inside. This is advantageous because it allows for greater flexion of fingers 78A-C and thus a lower required insertion force of tube 20 into retainer 70 (and connector body 40).

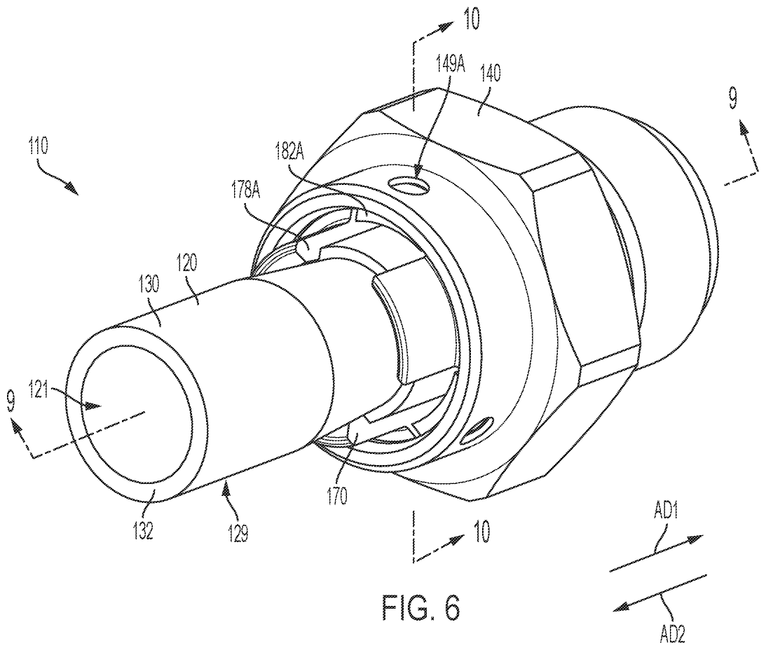

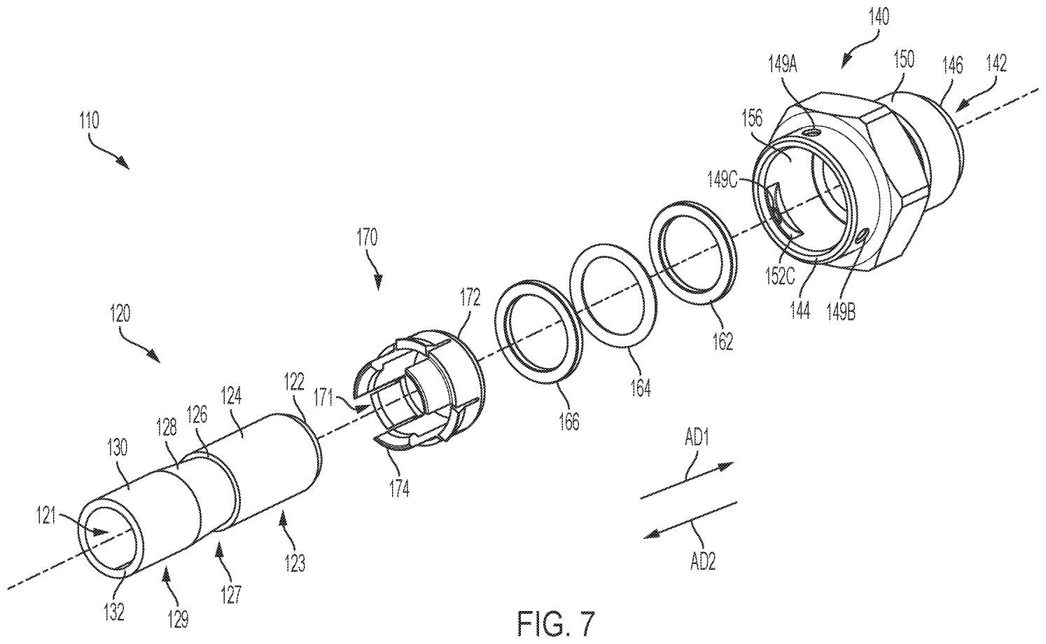

FIG. 6 is a perspective view of fluid connection assembly 110. FIG. 7 is an exploded perspective view of fluid connection assembly 110. Fluid connection assembly 110 generally comprises tube 120 or tube end form or hose, connector body 140, and retainer 170. The following description should be read in view of FIGS. 6-7.

Tube 120 comprises end 122, section 123, shoulder or groove 127, section 129, end 132, and through-bore 121. Through-bore 121 extends through tube 120 from end 122 to end 132. Section 123 is arranged between end 122 and shoulder 127 and comprises radially outward facing surface 124. Radially outward facing surface 124 includes a substantially constant diameter. Shoulder 127 is arranged between section 123 and section 129 and comprises shoulder (or axial) surface 126 and radially outward facing surface 128. Radially outward facing surface 128 is frusto-conical and decreases in diameter in axial direction AD1. Section 129 is arranged between shoulder 127 and end 132 and comprises radially outward facing surface 130. Radially outward facing surface 130 includes a substantially constant diameter. Tube 120 is arranged to be inserted, specifically with end 122 first, into connector body 140. Tube 120 is inserted into connector body 140, in axial direction AD1, until retainer 170 snaps over or into shoulder 127 and is generally engages surface 126 (i.e., fingers 178A-C are aligned with radially outward facing surface 128), as will be described in greater detail below It should be appreciated that tube 120 may be any traditional tube end form comprising a shoulder (e.g., a ramp or a bead), which extends radially outward on the outer surface of the tube, to displace a retainer of the connector body to secure the tube within the connector body. For example, tube 120 may comprise a shoulder including a straight ramp (i.e., constant linear ramp) or a curvilinear ramp. In some embodiments, tube 120 comprises any tube end form that might utilize a retainer. For example, instead of a groove, tube 120 may comprise a ramp, bead, notch, plurality of ramps, threading, shoulder having a variable diameter portion (ramp) and a constant diameter portion connected thereto, any standard Society of Automotive Engineers (SAE) end form, etc. The present disclosure should not be limited to the use of only the tube shown in the figures, but rather any tube end form suitable for fluidly connecting to a connector body via a retainer. It should be appreciated that in some embodiments, and as shown, tube 120 comprises a frusto-conical surface at end 122. Such frusto-conical surface engages with projections 180A-C, specifically frusto-conical surfaces 181A-C, to force fingers 178A-C radially outward during insertion of tube 120 into retainer 170.

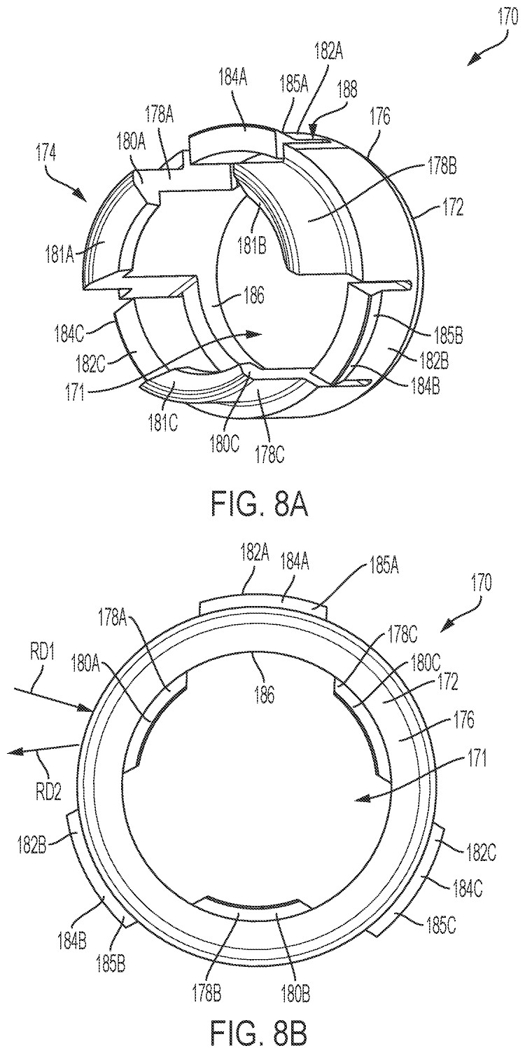

FIG. 8A is a perspective view of retainer 170. FIG. 8B is an elevational view of retainer 170. The following description should be read in view of FIGS. 6-8B.

Retainer 170 generally comprises ring portion 176 forming end 172 and a plurality fingers (e.g., fingers 178A-C and fingers 182A-C) extending from ring portion 176 and forming end 174. Ring portion 176 is generally ring shaped and comprises through-bore 171. In some embodiments, when retainer 170 is fully inserted into connector body 140, end 172 is operatively arranged to create the second half of the seal or O-ring gland, as will be described in greater detail below.

Fingers 178A-C extend from ring portion 176 in axial direction AD2 and are operatively arranged to engage shoulder 127 of tube 120. Fingers 178A-C comprise radially inward extending projections 180A-C, respectively. Projections 180A-C extend in radial direction AD1 and, when engaged with shoulder 127, lock tube 120 in retainer 170 (and connector body 140). Fingers 178A-C further comprise frusto-conical surfaces 181A-C, respectively. As tube 120 is inserted into retainer 170 in axial direction AD1, frusto-conical surfaces 181A-C engage radially outward facing surface 124 of section 123 forcing fingers 178A-C radially outward (i.e., in radial direction RD2). In a non-flexed state, projections 180A-C have an inner diameter that is less than the diameter of radially outward facing surface 124, which causes the outward displacement of fingers 178A-C when engaged with section 123. Once projections 180A-C are aligned with radially outward facing surface 128, fingers 178A-C snap back radially inward (i.e., in radial direction RD1) and secure tube 120 within retainer 170. Specifically, projections 180A-C engage radially outward facing surface 128 and surface 126 to prevent displacement of tube 120 in axial direction AD2 relative to retainer 170. Fingers 178A-C are elastic and are operatively arranged to flex and/or bend relative to ring portion 176. In some embodiments, retainer 170 comprises a polymer.

Fingers 182A-C extend from ring portion 176 in axial direction AD2 and are operatively arranged to engage pockets 152A-C and surface 154 of connector body 140. Fingers 182A-C comprise radially outward extending projections 184A-C, respectively. Projections 184A-C extend in radial direction AD2 and, when engaged with pockets 152A-C, specifically surface 154, lock retainer 170 in connector body 140. Fingers 182A-C further comprise frusto-conical surfaces 185A-C, respectively. As retainer 170 is inserted into connector body 140 in axial direction AD1, frusto-conical surfaces 185A-C engage end 144 of connector body 140 forcing fingers 182A-C radially inward (i.e., in radial direction RD1). Once projections 184A-C are aligned with pockets 152A-C, fingers 182A-C snap back radially outward (i.e., in radial direction RD2) and secure retainer 170 within connector body 140. Specifically, surface 154 of each of pockets 152A-C of connector body 140 engages projections 184A-C, thereby preventing displacement of retainer 170 in axial direction AD2 with respect to connector body 140. Fingers 182A-C are elastic and are operatively arranged to flex and/or bend relative to ring portion 176. In some embodiments, when retainer 170 is secured in connector body 140, fingers 182A-C and projections 184A-C are aligned with holes 149A-C. Such alignment allows a user to displace fingers 182A-C radially inward (i.e., in radial direction AD1) to disengage projections 184A-C from pockets 152A-C and remove retainer 170 from connector body 140. It should be appreciated that pockets 152A-C aid with proper alignment of fingers 182A-C with holes 149A-C. Furthermore, in some embodiments, when projections 184A-C are fully engaged with pockets 152A-C, retainer 170 is non-rotatably connected to connector body 140. Retainer 170 further comprises radially inward facing surface 186. Radially inward facing surface 186 is operatively arranged to engage tube 120, specifically radially outward facing surface 124 of section 123. In some embodiments, and as shown, fingers 178A-C and fingers 182A-C alternate circumferentially. In some embodiments, fingers 178A-C and fingers 182A-C do not alternate every single finger. In some embodiments, fingers 178A-C are separated from fingers 182A-C by slits 188. Slits 188 more elastic displacement (i.e., flex) between fingers 178A-C and 182A-C. It should be appreciated that in some embodiments, and as shown, retainer 170 comprises a frusto-conical surface at end 172. Such frusto-conical surface aids in properly aligning retainer 170 with respect to connector body 140 during insertion of retainer 170 into connector body 140.

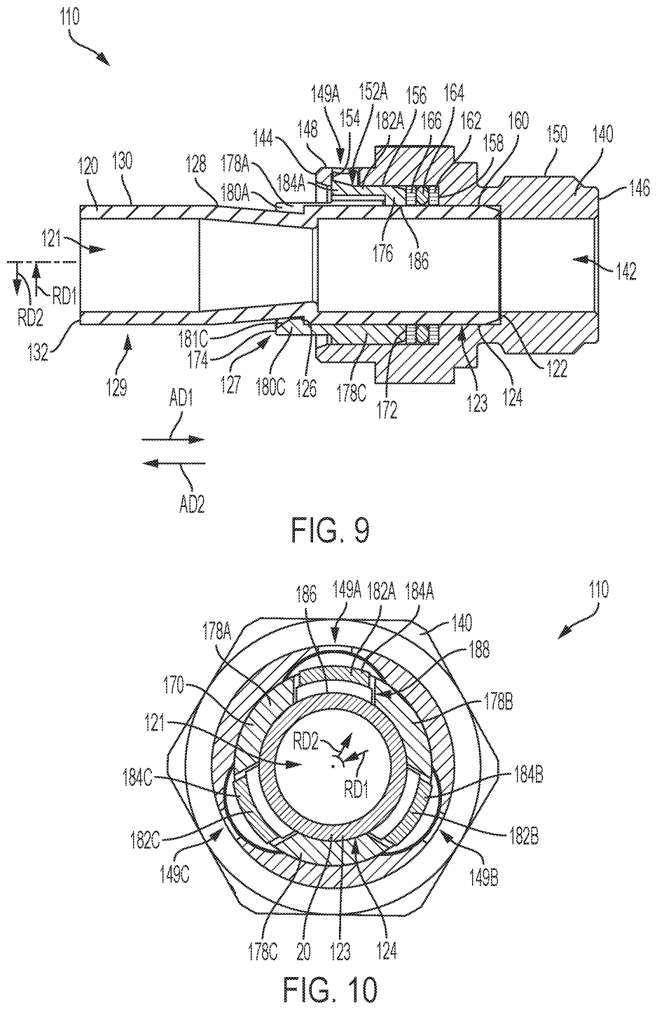

FIG. 9 is a cross-sectional view of fluid connection assembly 110 taken generally along line 9-9 in FIG. 6. FIG. 10 is a cross-sectional view of fluid connection assembly 110 taken generally along line 10-10 in FIG. 6. The following description should be read in view of FIGS. 6-10.

Connector body 140 comprises end 144, end 146, and through-bore 142 extending from end 144 to end 146. Connector body 140 comprises radially outward facing surface 148 comprising one or more release holes (e.g., 149A-C) and radially outward facing surface 150. Holes 149A-C are operatively arranged to align with fingers 182A-C and allow for a user to displace fingers 182A-C radially inward in order to disengage projections 184A-C from pockets 152A-C. Radially outward facing surface 150 is operatively arranged to connect connector body 140 to another component, and may comprise threading. Connector body 140 further comprises radially outward extending pockets 152A-C, each of pockets 152A-C including (axial) surface 154, radially inward facing surface 156, gland or surface 158, and radially inward facing surface 160. Radially inward facing surface 160 is operatively arranged to engage radially outward facing surface 124 of tube 120. Surface 158 and radially inward facing surface 156 are operatively arranged to at least partially enclose one or more seals (e.g., seals 162, 164, and 166). In some embodiments, fluid connection assembly 110 comprises an O-ring 162, backup ring 164, and backup ring 166 arranged in gland 158. When retainer 170 is locked in connector body 140, end 172 encloses seals 162, 164, and 166 completely within gland 158. Seals 162, 164, and 166 are operatively arranged to engage radially outward facing surface 124 to fluidly seal connector body 140 and tube 120. It should be appreciated that in some embodiments, gland 158 is arranged as a groove in radially inward facing surface 160 that fully encloses both sides of the one or more seals. In such embodiments, end 172 of retainer 170 does not enclose the seals within the gland. Pockets 152A-C, specifically surface(s) 154, are operatively arranged to engage projections 184A-C of fingers 182A-C to lock retainer 170 within connector body 140, as previously described. Radially inward facing surface 156 further engages a radially outward facing surface of retainer 170.

To assemble fluid connection assembly 110, seals 162, 164, and 166 are arranged in gland 158 and retainer 170 is then inserted in axial direction AD1, with end 172 first, into connector body 140. As retainer 170 is inserted into connector body 140, frusto-conical surfaces 185A-C of projections 184A-C engage end 144 of connector body 140 thereby displacing fingers 182A-C radially inward. Once projections 184A-C are properly aligned with pockets surface 152A-C, fingers 182A-C snap back radially outward, and projections 184A-C engage surface(s) 154 of pockets 152A-C thereby securing retainer 170 in connector body 140. Then tube 120 is inserted in axial direction AD1, with end 122 first, into retainer 170. As tube 120 is inserted into retainer 170, frusto-conical surfaces 181A-C of projections 180A-C engage section 123, specifically radially outward facing surface 124, displacing fingers 178A-C radially outward. Once projections 180A-C are aligned with radially outward facing surface 128, fingers 178A-C snap back radially inward, and projections 180A-C engage shoulder 127, specifically radially outward facing surface 128 and surface 126, thereby securing tube 120 in retainer 170.

It should be appreciated that, when retainer 170 is fully assembled to connector body 140, fingers 178A-C extend out of, in axial direction AD2, connector body 140. Thus, when tube 120 is subsequently inserted into retainer 170, protrusions 180A-C of fingers 178A-C engage shoulder 127 outside of connector body 140, rather than inside. This is advantageous because it allows for greater flexion of fingers 178A-C and thus a lower required insertion force of tube 120 into retainer 170 (and connector body 140).

It will be appreciated that various aspects of the disclosure above and other features and functions, or alternatives thereof, may be desirably combined into many other different systems or applications. Various presently unforeseen or unanticipated alternatives, modifications, variations, or improvements therein may be subsequently made by those skilled in the art which are also intended to be encompassed by the following claims.

### LIST OF REFERENCE NUMERALS

10 Fluid connection assembly
20 Tube (or tube end form or hose)
21 Through-bore
22 End
23 Section
24 Radially outward facing surface
26 Outward facing surface
27 Shoulder (or bead)
28 Radially outward facing surface
29 Section
30 End
40 Connector body
42 Through-bore
44 End
46 End
48 Radially outward facing surface
49A Hole
49B Hole
49C Hole
50 Radially outward facing surface
52 Protrusion
54 Surface
56 Surface
58 Gland (or surface)
60 Radially inward facing surface
62 Seal
64 Seal
70 Retainer
71 Through-bore
72 End
74 End
76 Ring portion
78A Finger
78B Finger
78C Finger
80A Projection
80B Projection
80C Projection
81A Surface
81B Surface
81C Surface
82A Finger
82B Finger
82C Finger
84A Projection
84B Projection
84C Projection
85A Surface
85B Surface
85C Surface
86A Radially inward facing surface
86B Radially inward facing surface
86C Radially inward facing surface
110 Fluid connection assembly
120 Tube (or tube end form or hose)
121 Through-bore
122 End
123 Section
124 Radially outward facing surface
126 Surface
127 Shoulder (or groove)
128 Radially outward facing surface
129 Section
130 Radially outward facing surface
132 End
140 Connector body
142 Through-bore
144 End
146 End
148 Radially outward facing surface
149A Hole
149B Hole
149C Hole
150 Radially outward facing surface
152A Pocket
152B Pocket
152C Pocket
154 Surface
156 Radially inward facing surface
158 Surface (or gland)
160 Radially inward facing surface
162 Seal
164 Seal
166 Seal
170 Retainer
171 Through-bore
172 End
174 End
176 Ring portion
178A Finger
178B Finger
178C Finger
180A Projection
180B Projection
180C Projection
181A Surface
181B Surface
181C Surface
182A Finger
182B Finger
182C Finger
184A Projection
184B Projection
184C Projection
185A Surface
185B Surface
185C Surface
186 Radially inward facing surface
188 Slits
AD1 Axial direction
AD2 Axial direction
RD1 Radial direction
RD2 Radial direction

What is claimed is:

1. A fluid connection assembly, comprising:
a connector body, including:
a first end;
a second end including a radially inward extending protrusion;
a first through-bore;
a gland; and
at least one seal arranged in the gland; and
a retainer operatively arranged to be removably connected to the connector body, the retainer including:
a ring portion forming a third end, the third end operatively arranged to enclose the at least one seal in the gland;
at least one short finger extending from the ring portion; and
at least one long finger extending from the ring portion and terminating at a fourth end;
wherein when the retainer is connected to the connector body the at least one long finger extends out of the connector body from the second end.

2. The fluid connection assembly as recited in claim 1, wherein the at least one short finger comprises a radially outward extending projection operatively arranged to engage the radially inward extending protrusion.

3. The fluid connection assembly as recited in claim 2, wherein the radially outward extending projection comprises a frusto-conical surface.

4. The fluid connection assembly as recited in claim 2, wherein:
the connector body further comprises a frusto-conical radially inward facing surface adjacent the protrusion; and,
the radially outward extending projection is operatively arranged to engage the frusto-conical radially inward facing surface.

5. The fluid connection assembly as recited in claim 4, wherein the connector body further comprises at least one hole aligned with the frusto-conical radially inward facing surface.

6. The fluid connection assembly as recited in claim 5, wherein when the retainer is connected to the connector body, the at least one hole is aligned with the at least one short finger.

7. The fluid connection assembly as recited in claim 1, wherein the at least one long finger comprises a radially inward extending projection.

8. The fluid connection assembly as recited in claim 7, further comprising a tube including a shoulder, wherein the radially inward extending projection is operatively arranged to engage the shoulder to lock the tube in the retainer.

9. The fluid connection assembly as recited in claim 1, wherein the at least one short finger and the at least one long finger are separated by at least one slit.

10. The fluid connection assembly as recited in claim 2, wherein the connector body further comprises a pocket, the radially outward extending projection operatively arranged to engage the pocket.

11. The fluid connection assembly as recited in claim 10, wherein the connector body further comprises at least one hole aligned with the pocket, wherein the at least one hole provides access to the radially outward extending projection.

12. The fluid connection assembly as recited in claim 1, wherein the retainer comprises a polymer.

13. A fluid connection assembly, comprising:
a connector body, including:
a first end;
a second end;
a first through-bore;
a gland; and
at least one seal arranged in the gland; and
a retainer removably connected to the connector body, the retainer including:
a ring portion;
a plurality of short fingers extending from the ring portion and operatively arranged to connect the retainer to the connector body; and
a plurality of long fingers extending from the ring portion;
wherein when the retainer is connected to the connector body, the plurality of long fingers extend out of the connector body from the second end.

14. The fluid connection assembly as recited in claim 11, wherein the connector body further comprises at least one recess arranged proximate the second end.

15. The fluid connection assembly as recited in claim 12, wherein each of the plurality of short fingers comprises a radially outward extending projection operatively arranged to engage the at least one recess to lock the retainer in the connector body.

16. The fluid connection assembly as recited in claim 13, wherein the connector body further comprises at least one hole aligned with the at least one recess, wherein when the retainer is connected to the connector body, the at least one hole provides access to the radially outward extending projections.

17. The fluid connection assembly as recited in claim 12, wherein the at least one recess comprises a continuous frusto-conical radially inward facing surface.

18. The fluid connection assembly as recited in claim 12, wherein the at least one recess comprises a plurality of circumferentially spaced pockets.

19. The fluid connection assembly as recited in claim 11, wherein:
the fluid connection assembly further comprises a tube including a shoulder;
each of the plurality of long fingers comprises a radially inward extending projection; and,
the radially inward extending projections are operatively arranged to engage the shoulder outside of the connector body to lock the tube to the retainer.

20. A fluid connection assembly, comprising:
a connector body, including:
a first end;
a second end;
a first through-bore;
a gland; and
at least one seal arranged in the gland;
a retainer removably connected to the connector body, the retainer including:
a ring portion operatively arranged to enclose the at least one seal in the gland;
at least one short finger extending from the ring portion, completely enclosed within the connector body, and operatively arranged to lock the retainer to the connector body; and
at least one long finger extending from the ring portion; and
a tube including a shoulder, wherein the at least one long finger engages the shoulder outside of the connector body to lock the tube to the retainer.
